(19) United States
(12) Patent Application Publication
(10) Pub. No.: US 2014/0314531 A1
(43) Pub. Date: Oct. 23, 2014

(54) Variable Pitch Equipment Cart With Roller Bed

(71) Applicant: Jackie L. Hearld, Huntington, WV (US)

(72) Inventor: Jackie L. Hearld, Huntington, WV (US)

(21) Appl. No.: 14/256,729

(22) Filed: Apr. 18, 2014

Related U.S. Application Data
(60) Provisional application No. 61/813,504, filed on Apr. 18, 2013.

(51) Int. Cl. B62B 3/02

(52) U.S. Cl. CPC B62B 3/02
USPC 414/495; 280/35; 414/529; 280/28.5

(57) ABSTRACT

The present device provides a device for transporting a load along a level or canted surface such as a rooftop. The device comprises a frame having a bed, and a plurality of movement facilitating components. The transported load rests atop a bed comprised of a plurality of freely-rotatable cylindrical tubes, along which the load may be manually moved rectilinearally in the course of loading the equipment onto or offloading the equipment from the present device. Each movement facilitating component is comprised of a chassis having a plurality of belted wheels. The chassis is articulatably connectable to height adjusting components. The assembled device has height adjusting components connected to the frame. When the present device moves along a surface, the belted wheels may orient to align with the surface contours and with the direction of movement of the present device.

### CROSS REFERENCE TO RELATED APPLICATIONS

This application is a utility application which claims priority to U.S. Provisional Application No. 61/813,504, filed on Apr. 18, 2013. The entire disclosures contained in U.S. Provisional Application No. 61/813,504, including the attachments thereto, are incorporated herein by reference.

### FIELD OF THE INVENTION

The present device is generally related to equipment carts and, more particularly, to equipment carts for hauling loads on level and canted surfaces while maintaining the load in an approximately horizontal position.

### BACKGROUND OF THE INVENTION

Structures such as office buildings, industrial facilities, shopping malls, etc. typically control interior air temperature and ventilation through the use of heating, ventilation, and air conditioning (HVAC) systems. HVAC systems typically include a rooftop package unit which may comprise a blower, heating or cooling element, filter racks or chambers, sound attenuators, dampers, electrical circuitry, etc.

HVAC package units are mounted on and supported by special structures often referred to as roof curbs. A typical roof curb is a raised mounting surface comprised of sections of heavy-gauge sheet metal. Sometimes, materials such as wooden two by four lumber are also used in constructing the roof curb. The features and function of roof curbs and of HVAC rooftop package units are known to those of ordinary skill in the art, and thus need not be described in detail herein.

HVAC rooftop package units are often quite heavy and may range, for example, between a few hundred pounds and several thousand pounds. The lower periphery of most HVAC units is usually comprised of a rail structure made from heavy-gauge sheet metal, which typically has slots and holes that are adapted for attaching common crane rigging cables or chains so that the heavy HVAC unit can be lifted onto or removed from a rooftop with a small crane or forklift.

In many roof installations there is considerable distance between the edge of the roof and the roof curb where the HVAC unit is to be placed or removed, so that certain cranes are too small to transport the HVAC unit to or from the roof curb location. Larger cranes are often used in such circumstances to reach the location of the roof curb where the package unit is to be mounted or removed. However, using a crane which is sufficiently large to move the HVAC unit along a significant expanse of rooftop may be impossible or impractical because of interference from high voltage power lines or other obstacles. Moreover, large cranes are relatively expensive, and would present an unnecessary or overly-burdensome expense for some applications such as removal of the HVAC package units during roof repair or resurfacing.

A helicopter may be used in some situations for transporting HVAC units across expansive roof tops and onto the roof curb, or for removing the unit from the roof curb. However, in addition to potential scheduling problems, employing the use of a helicopter may also entail considerable expense. Further, this method would demand appropriate weather conditions and lack of interference from power lines or other physical obstacles.

Many building structures have roofs that are essentially flat. Therefore, even when use of a helicopter or large crane is impossible or impractical as the sole manner for moving the HVAC unit, some existing equipment dollies may allow for manual maneuvering of an HVAC rooftop package unit along the roof surface with relative ease. However, the surfaces of some roofs are sloped, which increases the difficulty of loading an HVAC unit onto a transporting device and moving the unit along the roof top.

Another problem encountered on occasion is damage to rooftops caused by the pressure placed upon the roof surface from the wheels of a loaded equipment cart or dolly. One technique that is sometimes used to avoid such an occurrence is to place sections of plywood upon the roof surface along the path of transport. However, plywood may crack or break when used on a roof surface that is not sufficiently flat along the path of transport.

Sometimes, the HVAC unit itself sustains some degree of damage while being transported along a rooftop. The shell of many HVAC units is made of galvanized sheet metal. A typical heavy equipment cart or dolly is designed to secure the unit during transport by having some part of the cart's metal frame braced against or pressed against the sheet metal exterior of the unit. Such metal-on-metal contact may sometimes dent or scratch the surface of the HVAC unit.

Portable equipment carts of various types and designs have been used to move heavy equipment on the ground, or along surfaces having various slopes. However, to the inventor's knowledge, there has not been an equipment transporting device which combines portability, adaptability for various surface slopes, and ease of loading and offloading without damage to load or roof surface, in the same manner as the present device. Accordingly, there is a need for a relatively inexpensive, lightweight, portable apparatus that is easy to use and which is suitable for transporting an HVAC unit along relatively level rooftops, as well as along canted rooftops, while minimizing the risk that the transporting device will damage the roof surface or the unit itself.

### SUMMARY OF EMBODIMENTS OF THE INVENTION

One of the many embodiments of the present device is assembled from a plurality of relatively lightweight modules, to facilitate portability. Some embodiments comprise an equipment cart apparatus having a frame to which a plurality of adjustable height components are attached for maintaining a load in a relatively horizontal condition, while the load is being transported along a surface that is either relatively level or canted. The present device also functions to alleviate stress borne by the roof surface, and to augment the unloading of the transported equipment with relative ease and with minimal risk of damage to the surface of the equipment being transported.

In some of the many embodiments of the present device, each of a plurality of wheel components attaches pivotally to each of the adjustable height components, to enable the direction of movement to align the wheels, and to allow the wheel components to align with the degree of surface slope. In some embodiments, each wheel component includes a plurality of wheels. Such embodiments may also include a belt which winds around a plurality of wheels, to provide a load-bearing surface which efficiently distributes the weight being borne by the surface upon which the device of the present application is situated.

One of the many embodiments of the present device is comprised of a frame which, when assembled, is approximately square or rectangular in configuration. Some embodiments of the present device further comprise a plurality of height adjustment components, each of which attaches securely to a wheel component and functions independently of the other height adjustment components. A height adjustment component may be comprised of a plurality of screw members, each of which fits one or more coupling components.

One or more coupling components may be welded or otherwise securely attached to the frame. A screw member may freely rotate within one or more coupling components as the portion of the frame that is most proximal to the rotatable screw member raises and lowers.

Some embodiments of the present device include load support components, comprised of a plurality of freely rotatable cylindrical tubes upon which the load being transported rests, and which augment the ease with which the load is placed onto or offloaded from the present device while minimizing risk of damage to the outer surface of the load being transported. The present device may also comprise bushings located along the frame, and/or along or within the load support components, to reduce friction resulting from rotation of the tubes.

### BRIEF DESCRIPTION OF THE DRAWINGS

Additional utility and features of this device will become more fully apparent to those skilled in the art by reference to the following drawings, which illustrate some of the primary features of preferred embodiments.

FIG. 1 shows a perspective view of an exemplary HVAC unit.

FIG. 2 shows a perspective view of an embodiment of the present device, assembled, and with an HVAC unit loaded onto the device.

FIG. 3 shows a front view of a portion of a frame component and a portion of a bed component of the present device.

FIG. 4 shows a side view of a portion of a frame component and a portion of a bed component of the present device.

FIG. 5 shows a side view of a portion of a movement facilitating component of the present device.

FIG. 6 shows a side view of a movement facilitating component of the present device, with a height adjustment component attached thereto.

FIG. 7 shows a front view of a movement facilitating component of the present device, with a height adjustment component attached thereto.

FIG. 8 shows a front view of a top portion of a movement facilitating component of the present device, with a bottom portion of a height adjustment component attached thereto.

FIG. 9 shows a side view of a top portion of a movement facilitating component of the present device, with a bottom portion of a height adjustment component attached thereto.

FIG. 10 shows a perspective view of the bottom of a portion of a frame component of the present device, with a coupling component attached.

FIG. 11 shows a front view of a portion of a frame component of the present device, with coupling and height adjustment components attached.

### DETAILED DESCRIPTION OF EMBODIMENTS OF THE INVENTION

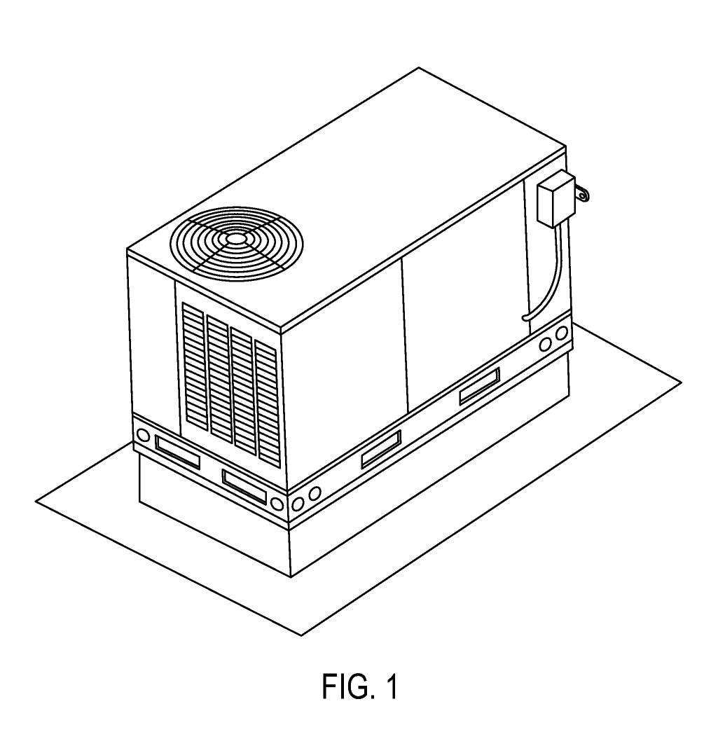

FIG. 1 shows a perspective view of an exemplary rooftop HVAC unit of the sort that may be transported by the present device. The present device may also be used to transport various other types of heavy equipment, and therefore is not limited to the transportation of rooftop HVAC units. In addition, the present device may transport equipment along various surfaces, and therefore is not limited to being used only on rooftops.

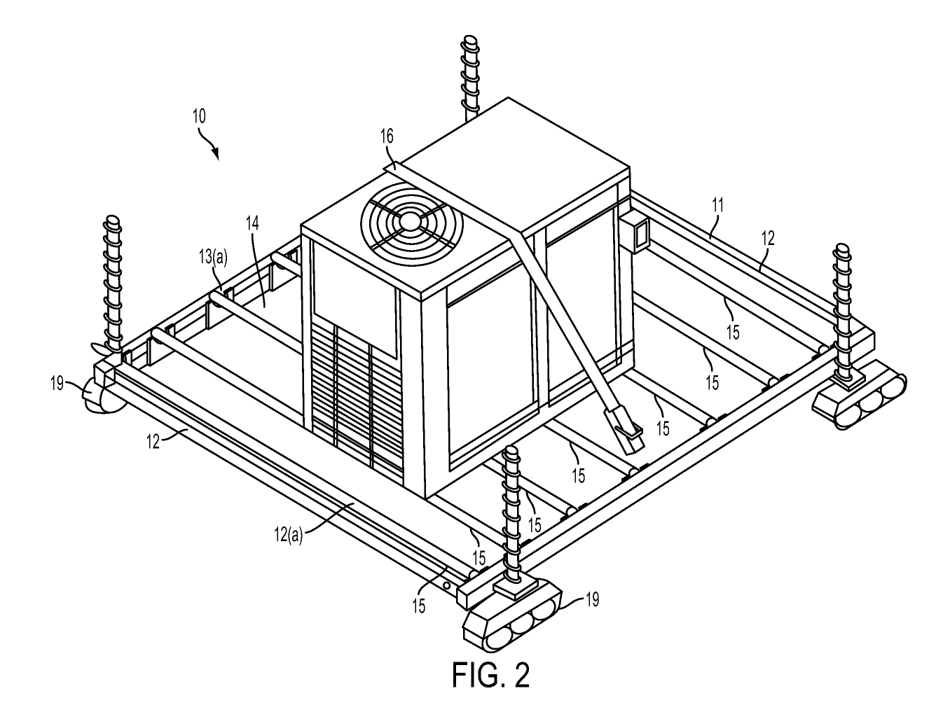

FIG. 2 shows a perspective view of an embodiment of equipment cart 10 of the present device. In FIG. 2, equipment cart 10 is assembled, and has a rooftop HVAC unit loaded onto it. Equipment cart 10 is comprised of frame 11. In one embodiment, frame 11 is comprised of stainless steel or other corrosion-resistant metal. In some embodiments, frame 11 is comprised of other high-strength material. Frame 11 is further comprised of two front rails 12. Front rails 12 are approximately of equal dimension to one another. In some embodiments, each front rail 12 is elongate, is of one-piece construction, and may be solid or hollow. In an embodiment of the present device, each front rail 12 is rectangular, and the two front rails 12 are aligned parallel to one another when equipment cart 10 is assembled. In some embodiments, front rails 12 may be cylindrical or oval in configuration.

Frame 11 is further comprised of one pair of side rails 13, each of which is of approximately equal dimension to the other. In one of the many embodiments, each side rail 13 is elongate, is of one-piece construction, and may be solid or hollow. In an embodiment of the present device, each side rail 13 is rectangular. In an embodiment of the present device, each side rail 13 is parallel to the other when equipment cart 10 is assembled, and perpendicular to front rails 12 so that assembled frame 11 is of square or rectangular configuration. In some embodiments, elongate side rails 13 may be cylindrical or oval in configuration.

In some embodiments, frame 11 is assembled by interlockably attaching front rails 12 with side rails 13. In some embodiments, front rails 12 are bolted to side rails 13. In some embodiments, front rails 13 are welded with side rails 12. In some embodiments, frame 11 is of one-piece construction.

Equipment cart 10 is further comprised of bed 14. In the embodiment in FIG. 2, bed 14 includes a plurality of elongate, cylindrically-configured tubes 15 which, when the present device is assembled, extend traversely of frame 11 and align approximately parallel to one another and to front rails 12. In some embodiments, tubes 15 may be solid or hollow, and may be comprised of corrosion-resistant metal. In some embodiments, the original metallic outer circumference of each tube 15 is coated by a layer of plastic or rubber material, so that the outer surface of the plastic-coated or rubber-coated tube 15 has a circumference greater than that of the outer surface of the original metal tube.

Referring again to FIG. 2, the railing at the bottom end of the load rests along tubes 15 which comprise bed 14 of the present device, so that no part of equipment cart 10 presses against or bears upon the HVAC unit, thus minimizing the risk that equipment cart 10 will dent, scratch, or otherwise damage the surface of the unit. In some embodiments, accessories such as straps 16, comprised of polyester or other high-strength, weather-resistant material, may be used to secure the equipment after it is loaded onto bed 14 of equipment cart 10.

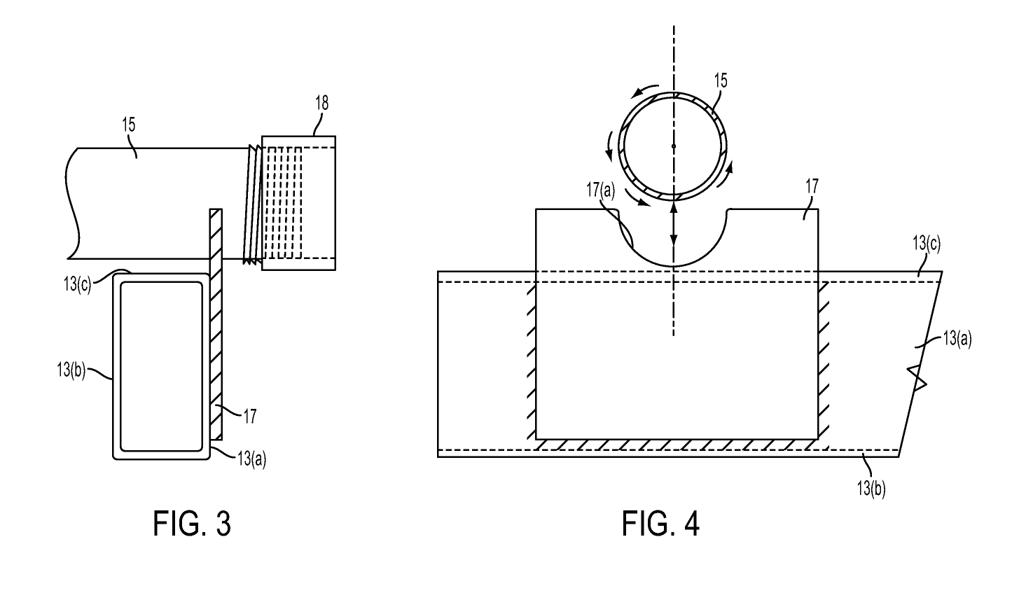

FIG. 3 shows a front view of side rail 13 along with a section of one end of tube 15. In the embodiment shown in FIG. 3, a plurality of yokes 17 is attached to each side rail 13. In the embodiment in FIG. 3, each of a plurality of yokes 17 is attached along outer wall 13(a) of side rail 13. In some embodiments, each of a plurality of yokes 17 is attached at other locations along side rail 13.

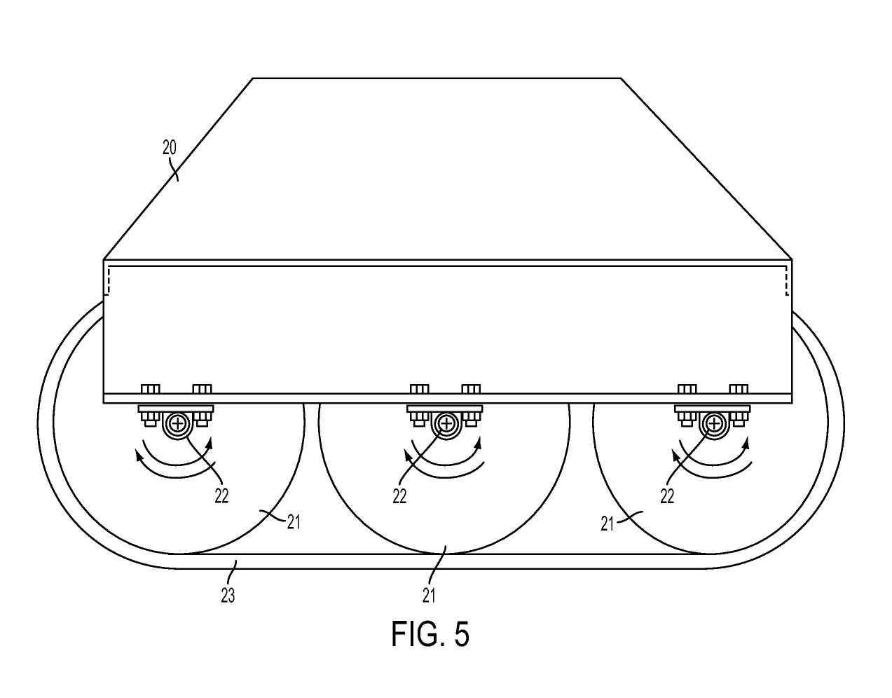

FIG. 4 shows a side view of the embodiment in FIG. 3. Each of a plurality of yokes 17 has notch 17(a). In FIG. 4, end of tube 15 is positioned above yoke 17 as though ready to fit into notch 17(a). When the embodiment shown in FIG. 3 and FIG. 4 is assembled, each of a plurality of tubes 15 fits, near a location at both ends of tube 15, within notch 17(a). The geometric configuration of notch 17(a) compliments the geometric configuration of tube 15 fitted within notch 17(a), to allow free rotation of tube 15. In some embodiments, tube 15 freely rotates along a plurality of corrosion-resistant metal bearings (not shown) disposed within a channel (not shown) along notch 17(a), to facilitate free rotation of tube 15 along notch 17(a). In some embodiments, free rotation of tube 15 along notch 17(a) is facilitated by a plurality of bearings (not shown) disposed along the portion of the outer circumference of tube 15 that fits within notch 17(a).

Referring again to FIG. 3, sleeve 18 is shown. Sleeve 18 may be cylindrical in configuration, and comprised of corrosion-resistant metal or other durable, solid material. In some embodiments, sleeve 18 comprises the outermost portion of each end of each of a plurality of tubes 15. In some embodiments, sleeve 18 is either welded or threadedly connected to each outermost end of each of a plurality of tubes 15. In some embodiments, sleeve 18 and tube 15 are not separate components. The geometric configuration of sleeve 18 is such that, when the embodiment shown in FIG. 3 is assembled and tube 15 fits within notch 17(a), sleeve 18 prevents tube 15 from slidably disengaging from yoke 17.

Referring to FIG. 2, when equipment cart 10 is fully assembled, the outermost circumference of each of a plurality of tubes 15 will be above top wall 12(c) of front rails 12 and top wall 13(c) of side rails 13. The free rotatability of each of a plurality of tubes 15 allows a load being borne upon bed 14 of equipment cart 10 to roll rectilinearally along a plurality of tubes 15.

Referring again to FIG. 2, equipment cart 10 further includes a plurality of movement facilitating components 19. The embodiment of equipment cart 10 shown in FIG. 2 is fully-assembled and comprised of four movement facilitating components 19.

Two movement facilitating components 19 are attached to each of two side rails 13 so that each of the four movement facilitating components 19 is in proximity to each of the four corners of frame 11. In some embodiments, said movement facilitating components 19 may be at different locations than the embodiment shown in FIG. 2 and/or may number more than four, or may number more than one but less than four.

In some embodiments, each movement facilitating component 19 is comprised of wheel chassis 20. Referring to FIG. 5, a side view of wheel chassis 20 is shown. In some embodiments, wheel chassis 20 is comprised of corrosion-resistant metal and partially covers a plurality of wheels 21. Wheel chassis 20 includes concentrically-located corrosion-resistant metal axles 22 around which each of a plurality of wheels 21 freely rotates when the present device moves along a rooftop or other surface. In some embodiments, each of the plurality of wheels 21 is comprised of non-pneumatic solid rubber material. In some embodiments, movement facilitating component 19 further includes a flexible belt 23, wound around a plurality of wheels 21. When belt 23 is wound around a plurality of wheels 21, a cross-sectional shape of belt 23 is an ellipse. In some embodiments, flexible belt 23 is comprised of an elastomeric material.

When equipment cart 10 is assembled and positioned upon a rooftop or other surface along which it is to move, outer circumference of belt 23 is in contact with the surface. In some embodiments, inner circumference of belt 23 has a plurality of ridges (not shown), and a plurality of grooves (not shown) are included along the outer circumference of each wheel 21 whose number, contour, and alignment compliment said ridges so that when equipment cart 10 is moved along a surface, rotation and movement of belt 23 compliments rotation and movement of wheels 21; and, so that belt 23 is prevented from slipping from wheels 21. Some embodiments of the present device use other modes to prevent slipping between belt 23 and wheels 21. In some embodiments, belt 23 and wheels 21 are aligned and contoured to complement wheel chassis 20, and to optimize the uniform distribution of pressure being borne upon the surface against which the outer circumference of belt 23 is in contact. Some embodiments employ a brake or skid system (not shown) for locking wheels 21 of equipment cart 10.

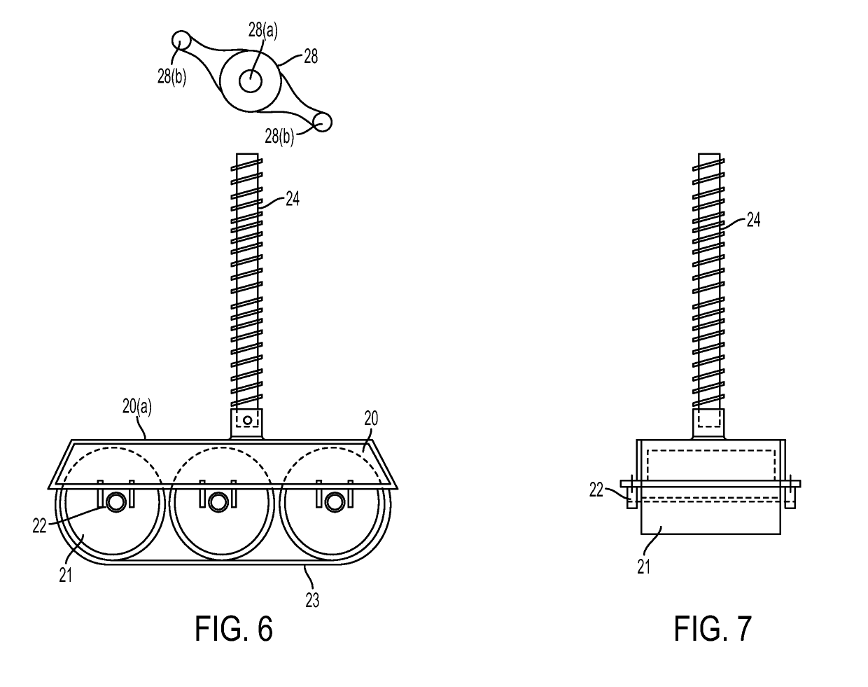

FIG. 6 shows a side view of wheels 21 and chassis 20 of an embodiment of the present device. Elongate, cylindrical, threaded member 24 is attached to and extending vertically from top 20(a) of wheel chassis 20. In some embodiments of the present device, threaded member 24 is comprised of corrosion-resistant metal. FIG. 7 is a front view of the embodiment shown in FIG. 6.

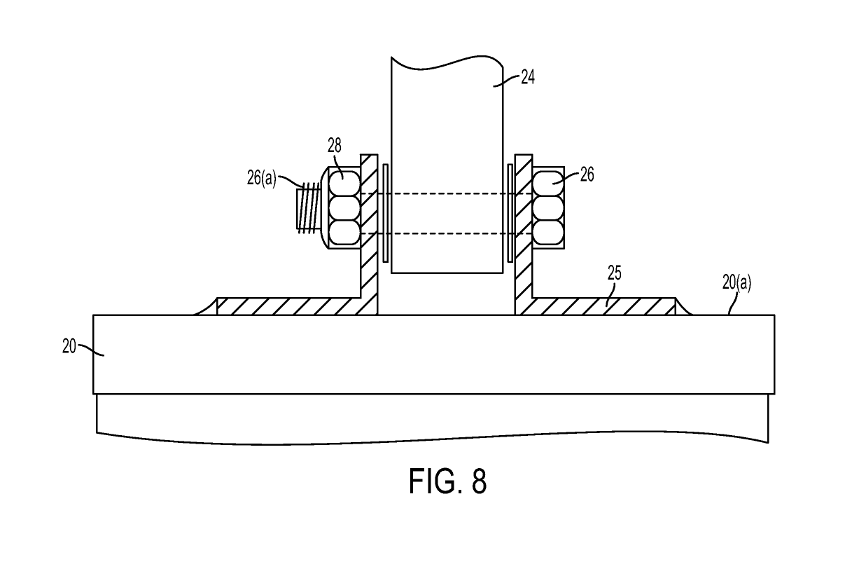

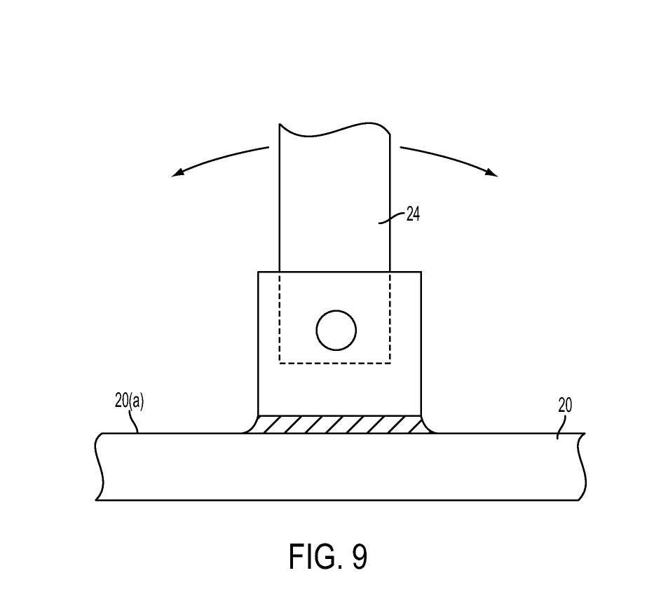

FIG. 8 shows a front view of top 20(a) of wheel chassis 20. FIG. 9 shows a side view of top 20(a) of wheel chassis 20. Referring to FIG. 8, brace or mount 25 comprised of corrosion-resistant metal is welded or otherwise securely attached to top 20(a) of wheel chassis 20. In the assembled device, elongate bolt 26 extends through apertures in brace or mount 25, and through aperture that describes the circumference of the end of threaded member 24 that is proximal to top 20(a). Threaded end 26(a) of bolt 26 is then met by threaded nut 26(b). Referring again to FIG. 9, threaded member 24 is thus pivotally secured to top 20(a) of wheel chassis 20. In some embodiments, brace or mount 25 may further comprise a collar (not shown) with a rotation assembly (not shown) that includes bearings to facilitate 360-degree rotation of a collar around an axis, so that movement facilitating component 19 may swivel to align with the direction of movement of equipment cart 10.

In some embodiments, threaded member 24 may be non-pivotally secured to brace or mount 25. Some embodiments may not include brace or mount 25. In such embodiments, threaded member 24 may be welded to or otherwise non-pivotally attached to top 20(a) of wheel chassis 20.

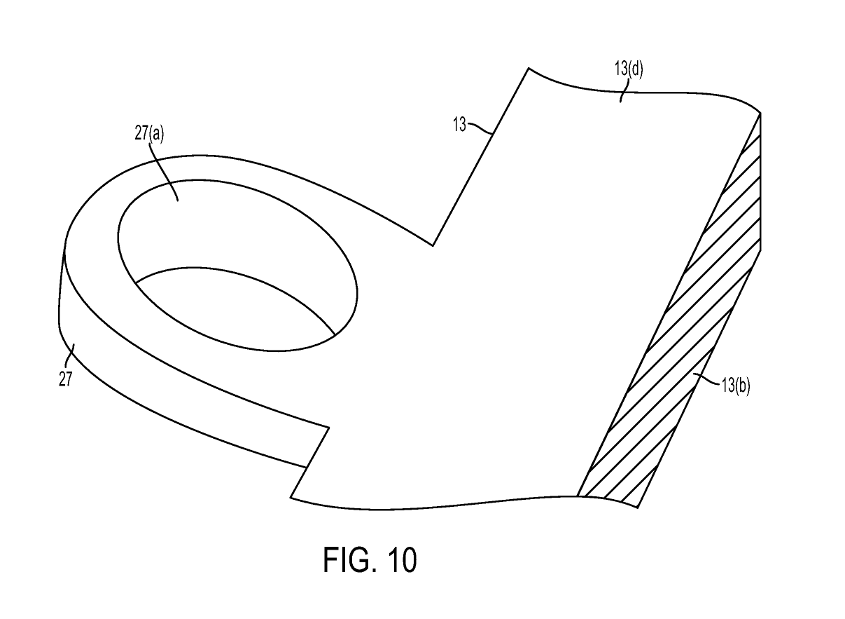

Referring to FIG. 10, coupler 27 comprised of corrosion-resistant metal is attached to side rail 13, proximal to bottom wall 13(d) of side rail 13. In some embodiments, coupler 27 is attached to a location along side rail 13 other than bottom wall 13(b). In the embodiment shown in FIG. 10, coupler 27 is further comprised of aperture 27(a). Aperture 27(a) is centrally-located along coupler 27 and is sized, configured, and oriented so that threaded member 24 fits through it, and so that if the assembled device rests upon a flat, level surface, threaded member 24 is perpendicular to said surface. In some embodiments of the present device, spiral-threaded member 24 may fit through more than one coupler 27.

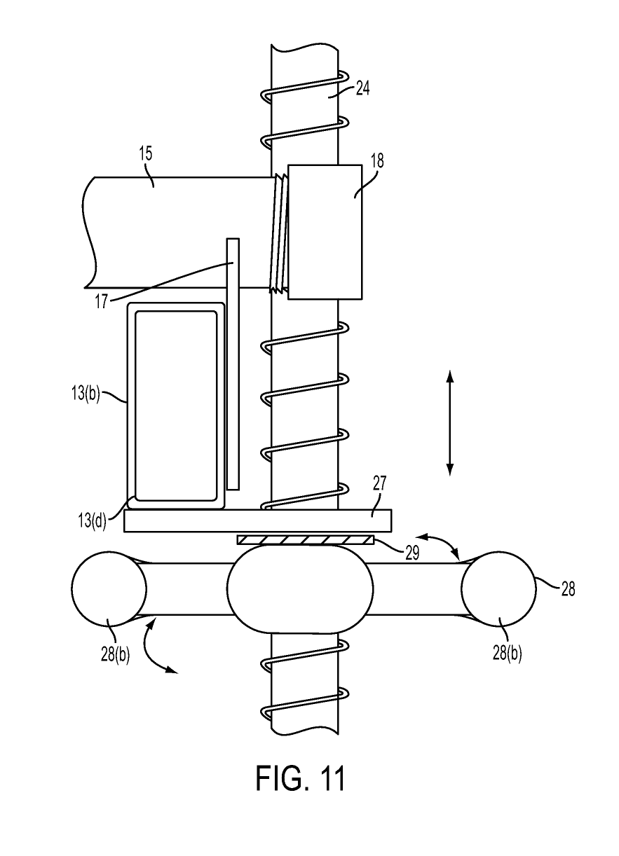

Referring to FIG. 11, a front view of a portion of frame 11 of an assembled embodiment of equipment cart 10 is shown. The embodiment in FIG. 11 shows threaded member 24 fitted through threaded aperture 28(a) in butterfly nut or handle 28. Referring again to FIG. 6, threaded aperture 28(a) is located concentrically of butterfly nut or handle 28, and has threads and circumference which accommodate rotatable fitting of threaded member 24 into threaded aperture 28(a) of butterfly nut 28.

In the embodiment shown in FIG. 11, threaded member 24 rotates to fit through and protrude from coupler 27. One or more handles 28(b) protrude from butterfly nut 28, and may be gripped and manually rotated to freely rotate butterfly nut or handle 28 in a clockwise and a counterclockwise direction, to raise and lower the area of frame 11 to which threaded member 24 is most proximally located.

Some embodiments of the present device may include washer 29. Referring again to the embodiment shown in FIG. 11, washer 29 may be located between butterfly nut or handle 28 and coupler 27. Washer 29 has a concentrically-located aperture (not shown) geometrically configured to accommodate fitting of threaded member 24 through aperture. In some embodiments, washer 29 may comprise a plurality of thrust ball bearings (not shown) describing an inner circumference of washer 29, which may facilitate reduction of rotational friction between butterfly nut or handle 28 and coupler 27 as frame 11 is raised and lowered via clockwise and counterclockwise rotation of butterfly nut or handle 28.

It is to be understood that the embodiments herein are not limited in application to the details of construction and arrangement of the components set forth in the description and illustrated in the drawings. Rather, the description and the drawings provide examples of the embodiments envisioned, but the present device is not limited to any particular embodiment or to a preferred embodiment disclosed and/or identified in the specification. The drawing figures are for illustrative purposes only, and merely provide practical examples of the equipment cart device disclosed herein. Therefore, the drawing figures should not be viewed as restricting the scope of the present application to that which the drawings depict.

The present application is further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is understood that the phraseology and terminology employed herein are for the purpose of description and should not be regarded as limiting the present application.

I claim:

1. A portable load-transporting device, comprising:
a rectangular frame, having a width and a length;
a load-bearing bed;
a frame lifting assembly; and
a movement facilitating assembly.

2. The portable load-transporting device of claim 1, wherein:
said bed is comprised of a plurality of freely-rotatable elongate cylindrical tubes;
said tubes aligned parallel to one another and traversing said frame width;
said tubes operable to support a load and facilitate rectilinear movement of said load along said bed.

3. The portable load-transporting device of claim 1, wherein:
said frame further comprises a first coupler attached along an outer periphery of said frame, proximal to a first corner of said frame;
a second coupler attached along an outer periphery of said frame, proximal to a second corner of said frame;
a third coupler attached along an outer periphery of said frame, proximal to a third corner of said frame; and
a fourth coupler attached along an outer periphery of said frame, proximal to a fourth corner of said frame;
each said first, second, third, and fourth coupler having a centrally-located aperture.

4. The portable load-transporting device of claim 1, wherein:
said frame lifting assembly comprises a first height adjustment assembly, including a cylindrical, elongate, threaded first member having a lower portion;
said lower portion of said first member articulatably mounted proximal to a top portion of a first movement facilitating assembly;
said first member sized and configured for insertion through an aperture of a first coupler;
said first height adjustment assembly further comprising a first handle having a centrally-located threaded aperture;
said aperture of said first handle sized and threaded to accommodate threaded insertion of said first member;
said first member forming a rotational axis around which attached said first handle freely, manually rotates clockwise and counterclockwise to move longitudinally along said first member.
said frame lifting assembly comprises a second height adjustment assembly, having a cylindrical, elongate, threaded second member having a lower portion;
said lower portion of said second member articulatably mounted proximal to a top portion of a second movement facilitating assembly;
said second member sized and configured for insertion through an aperture of a second coupler;
said second height adjustment assembly further comprising a second handle having a centrally-located threaded aperture;
said aperture of said second handle sized and threaded to accommodate threaded insertion of said second member;
said second member forming a rotational axis around which attached said second handle freely, manually rotates clockwise and counterclockwise to move longitudinally along said second member.
said frame lifting assembly comprises a third height adjustment assembly, including a cylindrical, elongate, threaded third member having a lower portion;
said lower portion of said third member articulatably mounted proximal to a top portion of a third movement facilitating assembly;
said third member sized and configured for insertion through an aperture of a third coupler;
said third height adjustment assembly further comprising a third handle having a centrally-located threaded aperture;
said aperture of said third handle sized and threaded to accommodate threaded insertion of said third member;
said third member forming a rotational axis around which attached said third handle freely, manually rotates clockwise and counterclockwise to move longitudinally along said third member.
said frame lifting assembly comprises a fourth height adjustment assembly, including a cylindrical, elongate, threaded fourth member having a lower portion;
said lower portion of said fourth member articulatably mounted proximal to a top portion of a fourth movement facilitating assembly;
said fourth member sized and configured for insertion through an aperture of a fourth coupler;
said fourth height adjustment assembly further comprising a fourth handle having a centrally-located threaded aperture;
said aperture of said fourth handle sized and threaded to accomodate threaded insertion of said fourth member;
said fourth member forming a rotational axis around which attached said fourth handle freely, manually rotates clockwise and counterclockwise to move longitudinally along said fourth member.

5. The frame lifting assembly of claim 4, wherein:
assembly of each said first, second, third, and fourth height adjustment assemblies has each said member extending through each said handle aperture and each said coupler aperture, with each said handle sandwiched between each said coupler and each said movement facilitating assembly; and,
manually rotating one or more said handles clockwise and counterclockwise moves said handle and said coupler longitudinally along said member, to raise and lower said frame vertically in relation to a surface on which said load transporting device rests.

6. The portable load-transporting device of claim 1, wherein:
said movement facilitating assembly includes a first chassis having a top portion along which a first member articulatably mounts, and has a housing for a plurality of spaced-apart wheels;
each wheel having an axis of rotation;
a single, elastomeric belt wrapped around said plurality of wheels;
said belt and said plurality of wheels adapted for non-slidable engagement between said belt and each said wheel;
said belt having an outer circumference providing a contact area for a surface along which said portable load transporting device moves;
said movement facilitating assembly includes a second chassis having a top portion along which a second member articulatably mounts, and has a housing for a plurality of spaced-apart wheels;
each wheel having an axis of rotation;
a single, elastomeric belt wrapped around said plurality of wheels;
said belt and said plurality of wheels adapted for non-slidable engagement between said belt and each said wheel;
said belt having an outer circumference providing a contact area for a surface along which a load transporting device moves;
said movement facilitating assembly includes a third chassis having a top portion along which a third member articulatably mounts, and has a housing for a plurality of spaced-apart wheels;
each wheel having an axis of rotation;
a single, elastomeric belt wrapped around said plurality of wheels;
said belt and said plurality of wheels adapted for non-slidable engagement between said belt and each said wheel;
said belt having an outer circumference providing a contact area for a surface along which a load transporting device moves;
said movement facilitating assembly includes a fourth chassis having a top portion along which a fourth member articulatably mounts, and has a housing for a plurality of spaced-apart wheels;
each wheel having an axis of rotation;
a single, elastomeric belt wrapped around said plurality of wheels;
said belt and said plurality of wheels adapted for non-slidable engagement between said belt and each said wheel;
said belt having an outer circumference providing a contact area for a surface along which said portable load transporting device moves.

7. The movement facilitating assembly of claim 6, wherein:
each said first, second, third, and fourth chassis rotates and pivots to conform to a surface contour and travel direction along which said load-transporting device moves.

8. The portable load-transporting device of claim 1, wherein:
said movement facilitating assembly supports an assembled load-transporting device atop a surface.

9. The portable load-transporting device of claim 1, wherein:
said device is modular in the sense that it comprises at least two components which releasably engage with one another and can be disassembled for ease of transport.
